(19) United States
(12) Patent Application Publication
(10) Pub. No.: US 2007/0183254 A1
(43) Pub. Date: Aug. 9, 2007

(54) Infinitely variable shear mixer apparatus

(76) Inventors: Desider Schobert-Csongor, Manchester, MA (US); Nick Reinhod Schott, Westford, MA (US); Karoly Belina, Budapest (HU)

Correspondence Address: Donald N. Halgren, 35 Central St, Manchester, MA, 01944, US

(21) Appl. No.: 11/581,761

(22) Filed: Oct. 16, 2006

Related U.S. Application Data
(60) Provisional application No. 60/730,211, filed on Oct. 25, 2005.

(51) Int. Cl. B01F 7/10; B29C 47/10

(52) U.S. Cl. 366/82; 366/307

(57) ABSTRACT

A mixing apparatus for the treatment of a plurality of flowable components. The apparatus comprises an elongated housing having an upper component-introduction end and a downstream compound-discharge end. An elongated shaft is rotatably disposed within an elongated bore disposed within the housing. The shaft has a stator and rotor arrangement spaced longitudinally therearound. At least one rotor has an arrangement of fluid channeling conduits spaced apart on an annular surface thereof, wherein the conduit is of tapering narrowing dimension from a first longitudinal side of the rotor to a second longitudinal side of the rotor.

### BACKGROUND OF THE INVENTION

1. Field of the Invention

The present invention relates to mixing apparatus and more particularly an infinitely adjustable extrusion machine for mixing together and treating a wide variety of flowable components to create a wide variety of output products therefrom, and is based upon U.S. Provisional Patent Application Ser. No. 60/730,211, filed Oct. 25, 2005 and incorporated herein by reference in its entirety.

2. Prior Art

Extrusion machines have been know for many years and have been utilized in the plastic industry for the melting, mixing and converting of pellet, flakes, powders and like flowable components into extruded fibers, and polymers or the like for making plastic parts or as sheets or films or raw material for subsequent treatment and use. Controlling the conditions and the ultimate output of such multiple components has often vexed the industry, particularly where it is desirable to include in the mix, very small size particles, particularly in the nano-technology field or to create multi-phase component polymer alloys.

It is an object of the present invention to provide a mixing arrangement which is variable in its mixing configuration to provide particulate output in a flow, which can be very tightly controlled and idealized for a desired use.

It is a further object of the present invention to provide a mixing apparatus in which the torque and shear rate can be adjusted and controlled and components of the apparatus may be readily reconfigured to provide optimum output.

### BRIEF SUMMARY OF THE INVENTION

The present invention relates to plasticating machines for mixing and incorporating multiple components such as for example, fibers, particles of wood and polymeric materials which are fed from satellite extruders. The configuration of the apparatus of the present invention comprises an elongated housing, generally of cylindrical shape, and may be split along the longitudinal, having a first or output end and a second or power drive end. The cylindrical housing has an elongated bore extending longitudinally therethrough. The elongated bore encloses a rotatable elongated shaft. The elongated shaft has an upper or driven end which is attached to a motorized drive shaft. The motorized drive shaft and the upper end of the elongated shaft are supported within bearings at the second or power drive end of the mixing apparatus. The elongated shaft at the upper or second end thereof, in the mixer apparatus has a spiral thread arranged therearound.

One, two or more “satellite” extruders may be in a fluid feed communication with the threaded portion of the elongated shaft near the second or power driven end of the mixer apparatus. The satellite extruder(s) feed components of the mix to be extruded through the mixer apparatus through ports in the sidewall of the elongated cylindrical housing. The rotation of the elongated shaft by the motorized drive shaft contributes to and helps effect propulsion of the components of the mix downwardly within the cylindrical housing.

The elongated shaft has a plurality of annularly shaped stators and rotors mounted within the elongated bore of that cylindrical housing. The stators and rotors configured in the present invention, may be arranged in an alternating series or may be arranged contiguous, so as to have adjacent stators and adjacent rotors or any combination thereof. The output or downstream end of the elongated shaft may have a further screw-like surface thereon at its adjacent output end. The threaded portion at the distal end presses outwardly on the extrudate and discharges it through a downstream port at the output end of the mixer apparatus.

The stators may be held in place within the elongated bore within the cylindrical housing by attachment bolts secured through bolt holes within the wall of the cylindrical housing. The attachment bolts extend into a recess in the peripheral surface of that particular stator to hold it securely therewithin. The elongated shaft would extend through a central opening within that stator as will be defined here and below. A rotor for the present invention, as aforesaid, is comprised of an annular or disc shaped component having a central bore therethrough. The central bore in each rotor may have a keyway extending longitudinally therewithin. The central bore of the rotor would mate about the periphery of the rotatable elongated shaft at a desired, variably changeable location thereon.

A stator similarly comprises an annular or disc shaped component having an axial bore extending longitudinally therethrough. The stator remains held in place in a stationary manner about the rotatable elongated shaft, within the elongated bore of the cylindrical housing. A first and a second bolt may be arranged through the wall of the cylindrical housing to engage to a depression within the outer peripheral wall of the stator to hold that stator secure and immovable during rotation of the elongated shaft therewithin.

In a first embodiment of a stator, the central bore extends therethrough for rotation of the elongated shaft. The central bore of the stator has an annular surface with a plurality of cuts or channels arranged within it inner annular surface. The cuts or channels may in one preferred embodiment, may be angled with respect to the longitudinal axis of the bore therewithin. Those angled cuts or channels within the inner surface of the bore in the stator may be irregular or smooth. Those cuts may be in longitudinal alignment with the longitudinal axis of the stator itself or in a further preferred embodiment may be disposed at an oblique angle with respect to the longitudinal axis of the stator and rotating elongated shaft therewithin.

Those cuts or channels within the internal peripheral or annular surface, or of a plurality of annularly distributed bores adjacent the inner annular surface of the stator in a further preferred embodiment thereof, may be tapered, pinched or narrowed from one longitudinal side of the stator to the other longitudinal side of the stator, preferably tapering narrower from an upstream side of the stator (or rotor) to a downstream side of the stator in a preferred embodiment thereof so as to accelerate and otherwise controllably affect the flow and manipulating of the mix thereby.

In yet a further preferred embodiment of the present invention, the disc like shaped stator may have its inner or internal bore having channels or spiral cuts spaced therewithin, and the stator may also have an outer peripheral surface with similar channels or spaced apart spirally arranged cuts therein. Those channels or cuts may themselves be tapered or in a downstream direction from a wider to a narrower dimension, as well as to a radially smaller dimension from a radially larger dimension at its upstream side.

Similarly, a rotor being an annular or disc shaped component having an upstream side and a downstream side with a cylindrically shaped bore extending therethrough. The rotor has a keyway which mates with a longitudinally directed key on a side of the elongated rotatable shaft to permit the rotor to engage and rotate with the elongated shaft as it rotates within the elongated bore of the cylindrically shaped housing. Each rotor has an outer peripheral surface with a plurality of channels or grooves thereon and/or with circumferentially spaced apart bores therethrough. The channels, bores and/or grooves in the rotor are preferably dimensionally changed from an upstream to a downstream dimension. Those channels or grooves are preferably narrower and smaller at the downstream side of the rotor than the upstream side.

Those channels or grooves in the outer peripheral surface of the rotor may be arranged in a helical or spiral-like configuration having roughened or smooth surface therein, in a further preferred embodiment thereof. It is also contemplated that those spiral grooves or channels may be tapered to a thinner or more narrow dimension from one side of the rotor to the other up or downstream side thereof. Thus it is possible with the components of the present invention, comprising numerous rotors and stators, to adjustably set and force and dispersably mix a number of components in a desired configuration by the utilization of rotors and stators each with specific dimensions and tapers in their channel configurations. Those channels with between upstream and downstream sides of the rotors and stators as aforementioned may also comprise holes or bores instead of peripheral surface cuts as aforesaid.

By developing a series of dimensional changes as you go downstream with the various stators and rotors in the bore of the cylindrical housing during a mixing operation, various outflow parameters may be set and output flows realized for particular compounds being admixed and treated. By numbering or setting a code for the channel configurations, for example, depth or width or length or roughness or dimension of taper or narrowing of channel or bore or chirality of spirals of particular rotors and stators, the mixing and processing of various compounds may be readily pre-configured, set according to a known flow/mix pattern and thus accomplished. The speed of the outflow and mixing may be increased as the mix goes through the tapered channels or bores, as through a venturri, so as to change/increase the flow rate and manipulate the desired mixing capabilities going therethrough. Improvements in such mixing and compounding may be accomplished, even on a nano scale compound.

Heating of the satellite extruders and their respective input, as well as heating and/or cooling the cylindrical housing and/or the stators running therewithin, may permit further manipulation and creativity of the admixing procedure.

The invention thus comprises a mixing apparatus for the treatment of a plurality of flowable components comprising: an elongated housing having an upper component-introduction end and a downstream compound-discharge end; an elongated shaft rotatably disposed within an elongated bore disposed within the housing, the shaft having a stator and rotor arrangement spaced longitudinally therearound, wherein at least one rotor has an arrangement of fluid channeling conduits spaced apart on an annular surface thereof, and wherein the channel/conduit is of tapering narrowing dimension from a first longitudinal side of the rotor to a second longitudinal side of the rotor. At least one stator has an arrangement of conduits spaced apart on an annular surface thereof, wherein the conduit is of a tapering dimension from a first longitudinal side of the stator to a second longitudinal side thereof. The first longitudinal side of the rotor may preferably correspond to an upstream side of the apparatus. The first longitudinal side of said stator preferably corresponds to an upstream side of the apparatus. At east one of the conduits may comprise a helical or spiral cut in its surface. The surface may comprise an outer annular surface on the rotor. The surface may comprise an inner annular surface on the rotor. The surface may comprise an outer annular surface on the stator. The surface may comprise an inner annular surface on the stator. At least one of the conduits may comprise a fluid treating bore extending generally longitudinally through the rotor. The fluid treating bore may have an upstream opening with a different geometrical shape than its downstream fluid flow exit opening to help achieve bi-axially oriented laminar formation of the compound during its processing.

The invention also comprises a method of providing an infinitely mixing capability to a plurality of particulate-fluid components through a fluid flow path mixing apparatus, comprising one or more of the following steps: arranging an array of rotors and stators in a mixing apparatus having a component-supplied upstream end and a downstream end; forming channels in the rotors and stators, at least one of the channels having a tapered geometry; and arranging the rotors and the stators in a particular array to provide a mix and shear effect thereto, as needed for the particular components fed to said apparatus; arranging the channels in the rotors and/or stators so as to be narrowed preferably in their downstream ends, to accelerate the movement of components being moved and treated therethrough; providing indicia on the rotors and the stators to indicate a particular known geometry of the channels therein, to permit the apparatus to be programmed and readily re-assembled to permit infinite adjustment and re-setting to a desired mix result, depending upon the need for the particular components being treated therethrough.

The arrangement of rotors and stators with their own channels creates flow division leading to a large increase in surface area in a multi-component feed which is very desirable for good mixing. Also the use of moving boundaries of rotors moving against stators and barrel surface leads to the creation of shear fields which vary with the geometry and rotor speed (Couette Flow). These shear fields are necessary for dispersive mixing to break up agglomerates. The use of convergent channels causes the fluid to accelerate which leads to extensional flow. The mixer apparatus creates specific morphology in the compound that affects both the physical and chemical properties and is highly desirable in multi-phase systems. The conveying action for output in the stator channels occurs via pressure flow (Poiseulle Flow). This flow sets up a shear field that is zero at the center of the channel and increases to a maximum at the wall. The apparatus of the present invention is capable of generating various mixing modes: Flow division; variable shear flow by a moving machine boundary; elongational flow due to a converging geometry and shear flow due to a pressure drop from the feed to the discharge end. Satellite mixers used with the present invention prepare the melt and components and are independently driven to feed the mixer. The mixer may be programmed for the correct shear and type of mixing via the use of particular marked rotors and stators. The speeds of the mixer andits satellite extruders are each adjustable individually to change the screw speeds. Also, each has its own barrel temperature control zones to control viscosity and torque.

### BRIEF DESCRIPTION OF THE DRAWINGS

The objects and advantages of the present invention will become more apparent, when viewed in conjunction with the following drawings in which:

FIG. 1 is a planned view of a mixing apparatus of the present invention being fed by a pair of satellite extruders;

FIG. 2 is a perspective view of the mixing apparatus shown in FIG. 1, without a cylindrical housing therearound;

FIG. 3 is a perspective view, in section showing a stator with its channels of grooved arranged within it inner peripheral bore;

FIG. 4 is a perspective view of the stator shown in FIG. 3, in full view of its entire outer periphery;

FIG. 5 is a view of a stator having grooves within its inner bore as well as grooves and channels within it outer periphery;

FIG. 6 is a sectional view of the stator shown in FIG. 5;

FIG. 7 is a perspective view of a rotor having its outer peripheral surface showing the tapered channels thereon; and

FIG. 8 is a perspective view of a rotor with an arrangement of spirally disposed channels tapered, thereon.

### DETAILED DESCRIPTION OF THE INVENTION

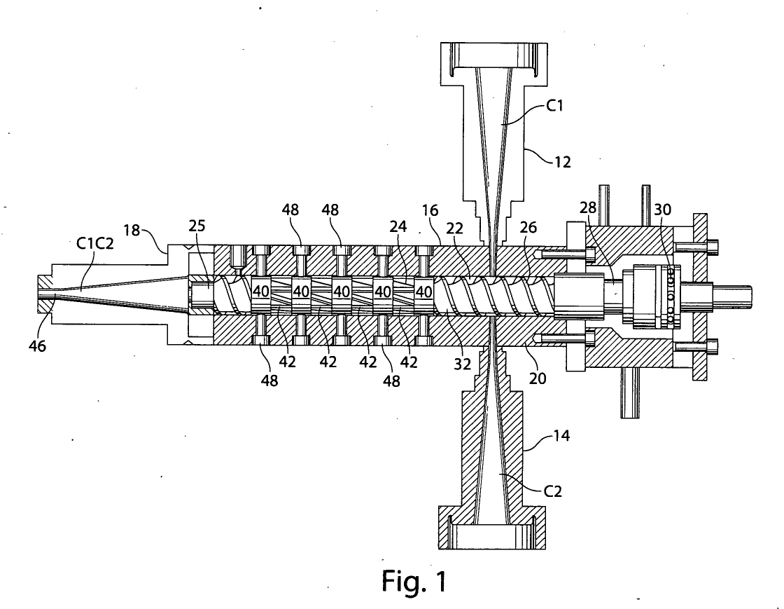

Referring in detail to the drawings of the present invention, and particularly to FIG. 1, there is shown a plasticating machine 10 in a sectional plan view, for mixing, extruding and treating multiple components C1 and C2 fed from an arrangement of satellite extruders 12 and 14. The mixing apparatus of the present invention comprises an elongated housing 16 generally of cylindrical shape, and may be split along the longitudinal, having a first or output end 18 and a second or power drive end 20. The cylindrical housing 18 has an elongated bore 22 extending longitudinally therethrough. The elongated bore 22 encloses a rotatable elongated shaft 24. The elongated shaft 24 has an upper or driven end 26 which is attached to a motorized drive shaft 28. The motorized drive shaft 28 and the upper (second) end 20 of the elongated shaft 24 are supported within bearings 30 at the second or power drive end of the mixing apparatus 10. The elongated shaft at the upper or second end thereof, in the mixer apparatus has a spiral thread 32 arranged therearound, as may be seen in FIG. 1.

One, two or more “satellite” extruders 12 and 14 are be in a fluid feed communication with the threaded portion 32 of the elongated shaft 24 near the second or power driven 20 end of the mixer apparatus 10. The satellite extruder(s) 12 and 14 feed components C1 and C2 of the mix to be extruded through the mixer apparatus 10 through ports 36 in the sidewall of the elongated cylindrical housing 16. The rotation of the elongated shaft 24 by the motorized drive shaft 28 contributes to and helps effect propulsion of the components C1 and C2 of the mix downwardly within the bore 22 of the cylindrical housing 16.

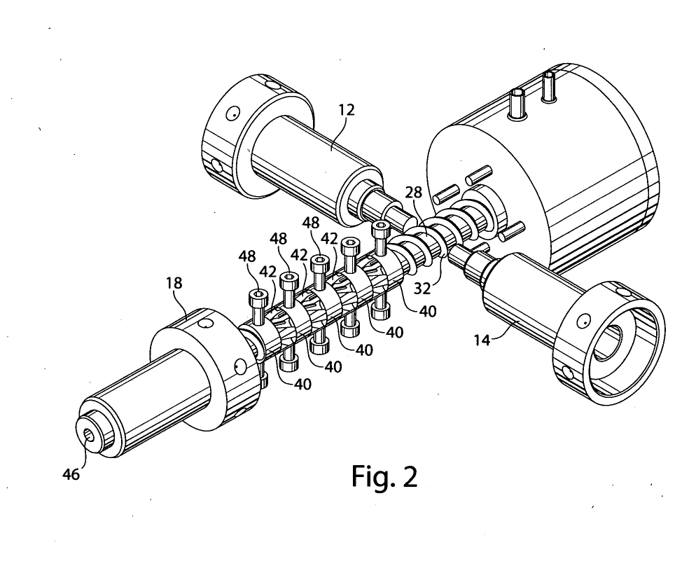

The elongated shaft 24 has a plurality of annularly shaped stators 40 and rotors 42 mounted within the elongated bore 22 of that cylindrical housingl6. The stators 40 and rotors 42 configured in the present invention, may be arranged in an alternating series, as represented for example, in FIGS. 1 and 2, or they may be arranged contiguous, so as to have adjacent stators 40 adjacent one another and/or rotors 42 adjacent one another, or any combination thereof. The output or downstream end 25 of the elongated shaft 24 may have a further screw-like surface 44 thereon at its output end. The threaded portion 44 at the distal end of the shaft 24 presses outwardly on the extrudate C1C2 and discharges it through a downstream port 46 at the output end 18 of the mixer apparatus 10. It is to be noted that the particular stators 40 and rotors 42 may be numbered, as for example “I”, in FIG. 8, and categorized to permit this apparatus 10 to have a pre-set array of rotors 42 and stators 40 which will treat a specific set of components in a particular known manner which may be readily repeatable by returning to the pre-set numbers of rotors 42 and stators 40 mountable about the rotatable shaft 24, as needed.

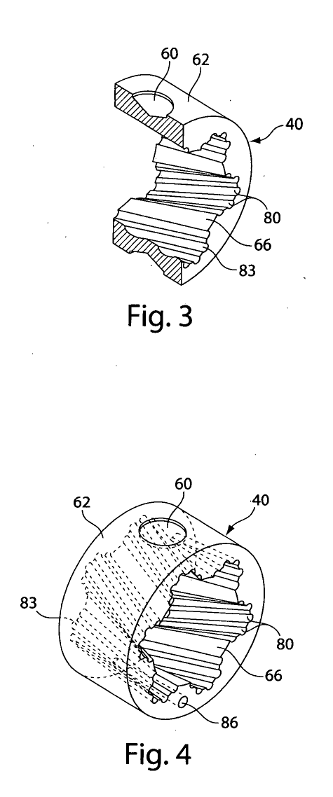

The stators 40 may be held in place within the elongated bore 24 within the cylindrical housing 16 by attachment bolts 48 secured through bolt holes 50 within the wall of the cylindrical housing 16. The attachment bolts 48 may extend into a recess 60 in the peripheral surface 62 of that particular stator 40, as represented in FIGS. 3, 4, 5 and 6, to hold it securely therewithin. The elongated shaft 24 would extend through a central longitudinally directed opening 66, as represented in FIGS. 3, 4,5 and 6, within that stator 40 as will be further defined hereinbelow.

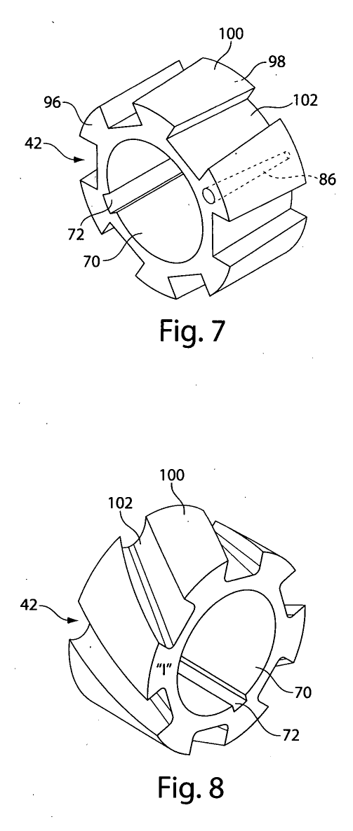

A rotor 42 for the present invention, as represented in FIGS. 7 and 8, is comprised of an annular or disc shaped component having a central bore 70 therethrough. The central bore 66 in each rotor 42 may have a keyway 72 extending longitudinally therewithin. The central bore 66 of the rotor would mate about the periphery of the rotatable elongated shaft 24 at a desired, variably changeable location thereon.

A stator 40. as aforementioned, similarly comprises an annular or disc shaped component having its axial bore 66 extending longitudinally therethrough. The stator 40 remains held in place in a stationary manner about the rotatable elongated shaft 24, within the elongated bore 22 of the cylindrical housing 16. A first and a second bolt 48 may be arranged through the wall of the cylindrical housing 16 to engage to its depression 60 within the outer peripheral surface 62 of the stator 40 to hold that stator 40 secure and immovable during rotation of the elongated shaft 24 therewithin.

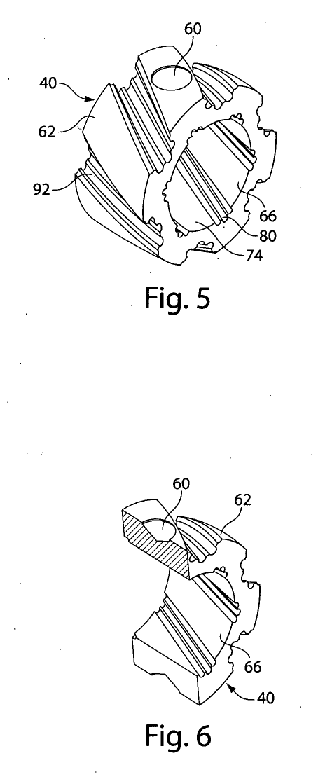

In a first embodiment of a stator 40, as represented in FIG. 3, the central bore 66 extends therethrough for rotation therethrough of an elongated shaft. The central bore 66 of the stator 40 has an annular surface 74 shown in FIG. 5, with a plurality of cuts or channels 80 arranged in its inner annular surface 74. The cuts or channels 80 may in one preferred embodiment, may be angled with respect to the longitudinal axis “L” of the bore therewithin. Those angled cuts or channels 80 within the inner surface 74 of the bore in the stator 40 may be irregular, that is roughened as shown in FIG. 4 or smooth, as represented in FIG. 5. Those cuts may be in longitudinal alignment with the longitudinal axis “L” of the stator 40 itself or in a further preferred embodiment may be disposed at an oblique angle with respect to the longitudinal axis “L” of the stator 40 and the axis of a rotating elongated shaft therewithin. The tapered channels may be conical or narrowed to provide acceleration to the compounds working its way downstream, or the tapers may be narrow at their upstream end to slow down the movement of the mix. During the “accelerated” fluid flow, the particulate mix is elongated from rotor/stator to stator/rotor. The flow pattern may thus be changed and controlled depending upon the channel geometries in the stators and rotors to provide an infinitely variable shear mix path of components being fed to the apparatus 10.

Those cuts or channels 80 within the internal peripheral or annular surface 74, or of a plurality of annularly distributed bores 86 (which bores 86 may have oval, circular, elliptical or rectilinear upstream/downstream inlets and outlets, which inlets and outlets may differ from one another in size and shape, not shown for clarity of view) adjacent the inner annular surface 74 of the stator 40, as represented in FIG. 4, or through a rotor 42 in a further preferred embodiment thereof, as represented in FIG. 7, may be tapered from one longitudinal side of the stator 40 (or rotor 42, as in FIG. 7), to the other longitudinal side of the stator 40, preferably tapering narrower from an upstream side of the stator 40 to a downstream side of the stator 40 in a preferred embodiment thereof so as to accelerate and otherwise controllably affect the flow and manipulation of the mix thereby.

In yet a further preferred embodiment of the present invention, the disc like shaped stator 40 may have its inner or internal bore 74 having channels 80 as spiral cuts 83 spaced therewithin, and the stator 40 may also have an outer peripheral surface 88 with similar channels 90 or spaced apart spirally arranged cuts 92 therein, as represeneted in FIGS. 5 and 6. Those channels or cuts 90 and 92 may themselves be tapered or in a downstream direction from a wider to a narrower dimension, as well as to a radially smaller dimension from a radially larger dimension at its upstream side.

Similarly, a rotor 42 being an annular or disc shaped component having an upstream side 96 and 98 and a downstream side with a cylindrically shaped bore 70 extending therethrough, is represented in FIGS. 7 and 8. The rotor 42 has its keyway 72 to mate with a longitudinally directed key, not shown for clarity of drawings, on a side of the elongated rotatable shaft 24, to permit the rotor 42 to engage and rotate with the elongated shaft 24 as it rotates within the elongated bore 22 of the cylindrically shaped housing 16. Each rotor 42 has an outer peripheral surface 100 with a plurality of channels or grooves 102 thereon and/or with circumferentially spaced apart bores 86 therethrough, as represented in FIG. 7. The channels 92, bores 86 and/or grooves 92 in the rotor 42 are preferably dimensionally changed from an upstream to a downstream dimension. Those channels or grooves 92 or bores 86 are preferably narrower and smaller at one side, preferably the downstream side of the rotor 42 than the upstream side.

Those channels or grooves 102 in the outer peripheral surface 100 of the rotor 42 may be arranged in a spiral-like configuration, shown in FIG. 8, having roughened or smooth surface therein, in a further preferred embodiment thereof. It is also contemplated in a further embodiment, that those spiral grooves or channels 102 may be tapered to a thinner or more narrow dimension from one side of the rotor 42 to the other up or downstream side thereof. Thus it is possible with the components of the present invention, comprising numerous rotors and stators, to adjustably set and force and dispersably mix a number of components in a desired configuration by the utilization of rotors and stators each with specific dimensions and tapers in their channel configurations. Those channels 88, 92 with between upstream and downstream sides of the rotors and stators as aforementioned may also comprise holes or bores 86 instead of peripheral surface cuts as aforesaid.

By developing a series of dimensional changes going downstream with the various stators 40 and rotors 42 in the bore 22 of the cylindrical housing 16 during a mixing operation, various outflow parameters may be set and output flows realized for particular compounds being admixed and treated. By numbering or setting a code for the channel configurations, for example, depth or width or length or roughness or dimension of taper or narrowing of channel or bore or chirality of spirals of particular rotors and stators, the mixing and processing of various compounds may be readily pre-configured, set according to a known flow/mix pattern and thus accomplished. The speed of the outflow and mixing may be increased as the mix goes through the tapered channels or bores, as through a venturri, so as to change/increase the flow rate, elongating the fluid components as they flow downstream through the channels/bores and manipulate the desired mixing capabilities going therethrough. Improvements in such mixing and compounding may be accomplished, even on a nano scale compound.

Heating of the satellite extruders 12 and 14, and their respective input, as well as heating and/or cooling the cylindrical housing 16 and/or the stators 40 running therewithin, may permit further manipulation and creativity of the admixing procedure, being able to treat the components, even nano-sized components dispersively, to blend them in a dispersive and distributive manner, increasing the surface area of the compound by biaxial admixing thereof.

1. A mixing apparatus for the treatment of a plurality of flowable components comprising:
an elongated housing having an upper component-introduction end and a downstream compound-discharge end;
an elongated shaft rotatably disposed within an elongated bore disposed within said housing, said shaft having a stator and rotor arrangement spaced longitudinally therearound;
wherein at least one rotor has an arrangement of fluid channeling conduits spaced apart on an annular surface thereof, wherein said conduit is of tapering narrowing dimension from a first longitudinal side of said rotor to a second longitudinal side of said rotor.

2. The mixing apparatus as recited in claim 1, wherein at least one stator has an arrangement of conduits spaced apart on an annular surface thereof, wherein said conduit is of a tapering dimension from a first longitudinal side of said stator to a second longitudinal side thereof.

3. The mixing apparatus as recited in claim 1, wherein said first longitudinal side of said rotor corresponds to an upstream side of said apparatus.

4. The mixing apparatus as recited in claim 1, wherein said first longitudinal side of said stator corresponds to an upstream side of said apparatus.

5. The mixing apparatus as recited in claim 1, wherein said at least one of said conduits comprises a spiral cut in said surface.

6. The mixing apparatus as recited in claim 1, wherein said surface comprises an outer annular surface on said rotor.

7. The mixing apparatus as recited in claim 1, wherein said surface comprises an inner annular surface on said rotor.

8. The mixing apparatus as recited in claim 2, wherein said surface comprised an outer annular surface on said stator.

9. The mixing apparatus as recited in claim 2, wherein said surface comprises an inner annular surface on said stator.

10. The mixing apparatus as recited in claim 1, wherein at least one of said conduits comprises a fluid treating bore extending generally longitudinally through said rotor.

11. The mixing apparatus as recited in claim 10, wherein said fluid treating bore has an upstream opening with a different geometrical shape than its downstream fluid flow exit opening to help achieve bi-axially oriented laminar formation of the compound during its processing.

12. A method of providing an infinitely mixing capability to a plurality of particulate-fluid components through an adjustably-controllable fluid-flow-path mixing apparatus, comprising:
arranging an array of rotors and stators in a mixing apparatus having a component-supplied upstream end and a downstream end;
forming channels in said rotors and stators, at least one of said channels having a tapered geometry; and
arranging said rotors and stators in a particular array to provide a mix and shear effect thereto, as needed for the particular components fed to said apparatus.

13. The method as recited in claim 12, including:
arranging said channels in said rotors and stators wherein said channels are narrowed toward their downstream ends, so as to accelerate the movement of components being moved and treated therethrough.

14. The method as recited in claim in claim 12, including:
providing indicia on said rotors and stators to indicate a particular geometry of said channels therein, to permit said apparatus to be readily re-assembled to permit infinite adjustment and re-setting to a desired mix result, depending upon the need for the particular components being treated therethrough.
